(19) United States
(12) Patent Application Publication
(10) Pub. No.: US 2014/0081842 A1
(43) Pub. Date: Mar. 20, 2014

(54) BINIOG SATHI APPARATUS, SYSTEM, AND A METHOD THEREOF

(71) Applicant: Mabroor Mahmood, Dhaka (BD)

(72) Inventor: Mabroor Mahmood, Dhaka (BD)

(21) Appl. No.: 13/621,682

(22) Filed: Sep. 17, 2012

(51) Int. Cl. G06Q 40/02

(52) U.S. Cl. 705/39

(57) ABSTRACT

The invention encompasses a Biniog Sathi apparatus, system, and a method thereof. The present invention relates generally to an inventive concept in investment and charitable contributions. The present invention also contemplates modifying the existing banking model with the incorporation of a Zakat or charity fund that will allow the financial institutions to mitigate the default risk for loans. This invention finds a sustainable solution to the problems of debt default in the financial services industry with the help of Zakat or charity hinds. It also strengthens the existing Islamic banking model complying with all the sharia principles. This invention develops a banking model that will be acceptable to all individuals and businesses seeking loans irrespective of race, color, religion, social class, to name a few.

### FIELD OF THE INVENTION

The present invention relates generally to an inventive concept in investment and charitable contributions. More particularly, the invention encompasses a Biniog Sathi apparatus, system, and a method thereof. The present invention also contemplates modifying, the existing banking model with the incorporation of a Zakat or charity fund that will allow the financial institutions to mitigate the default risk for loans.

### BACKGROUND INFORMATION

In the financial services industry a major problem is debt default, and this problem persists in the financial services industry throughout the world. Any bank, no matter whether it is a conventional bank, an Islamic bank, or a micro-finance institution, they are all exposed to the possibility of debt default by its borrowers.

At present, there are at least three types of banking models that are being operated all over the world. The first and most popular one is the conventional banking system, which is based on interest based principles. The second is the Islamic banking model, which is guided by the Islamic Sharia principles. The third is the microfinance system, which is based on collective group approach.

In microfinance institutions loans are extended to poor people, micro-entrepreneurs, and small businesses, without any collateral. On the other hand, in the Islamic financial institutions, the financing modes are free of interest or Riba, and usually involve the ownership of assets by the bank, complying the Islamic Sharia principles.

All these banking models have common problems of loan default, which basically means that if the borrower is unable to repay the loans, the lender forces the borrower to pay-off the loans either through selling of the assets or through filing claims on the securities in the court, or similar other loan collection method. Under these circumstances a borrower, if he/she is a true defaulter, faces innumerable financial losses that eventually might ruin his/her life.

Although the above mentioned banking models are different in their operational mechanisms, the basic structure of the banking model is similar in terms of their treatment to the borrowers in case of default. In all the banking models mentioned above, there is no existing mechanism for assisting the borrowers if they default on their loans.

These debt defaults occur in the financial services industry due to a variety of reasons, such as, for example, changes in economic climate, mismanagement of assets, not enough collateral to support the debt, to name a few.

Various efforts have been done in the past to address this persistent problem in the financial sector, but they have had limited success.

U.S. Pat. No. 5,466,919 (Henry Hovakimian), the entire disclosure of which is incorporated herein by reference, discloses a method which enables a credit cardholder to make a donation to a cardholder-selected charity any time he makes a purchase using the credit card. The method comprises a credit/charge card which identifies on its magnetic strip, charities to receive a donation, and a bank expedited system which processes the card user's purchase transaction, pays a previously decided amount to the charity or charities and also bills the cardholder. In this system, the donated amounts may be paid by the bank or card issuing organization, or the cardholder may add an amount which he pays to the selected charity. The proposed system may be described as being a bank expedited charity donation, (abbreviated to BAX) approach for credit/charge cardholders.

U.S. Pat. No. 6,519,573 (Randi Shade, et al.), the entire disclosure of which is incorporated herein by reference, discloses a new method and system for enabling three-party charitable gift giving. A host operates a central server, such as a web site, and potentially other support services, such as telephonic support. A gift giver visits the host web site and selects a donation amount and a gift recipient. The host then transmits the charitable gift to the gift recipient, along with a unique code which enables the gift recipient to redeem the charitable gift. The gift recipient then visits the host web site, selects a charity from a list of available options, and the gift is sent to the selected donee charity by the host.

U.S. Pat. No. 6,542,875 (Steven Mulvihill, et al.), the entire disclosure of which is incorporated herein by reference, discloses a limited partnerships formed for specified public purposes, such as qualified low-income and elderly housing construction and services, are federally tax advantaged. In accordance with the present invention, tax credits and/or passive losses are leveraged by being directed into a method of funding charitable works, for instance school construction projects. A $1 million investment in a qualifying tax credit and/or passive loss plan, with recoupment of the investment after 13 years, will return 8.05% after taxes over 13 years if 50% of the tax credit amounts are donated to a qualified charity or public entity; this results in a net benefit to the donor of $1,759,450 and a total contribution to the charitable entity of $615,000. That contribution can, in accordance with the invention, fund the issuance and retirement of municipal bonds secured principally by the contribution, sufficient for a school construction project of about $500,000.

U.S. Pat. No. 7,593,881 (Howard E. Winklevoss, et al.), the entire disclosure of which is incorporated herein by reference, discloses methods and systems for facilitating donor-directed asset management are provided. In one embodiment, a program agreement may be established between a donor and a donee and an asset may be donated from the donor to the donee. The program agreement may specify, among other things, a period of time for investing the asset. The donor may invest the asset after donating it to the donee according to the terms of the program agreement. The investment of the asset may be monitored by an administrator to help ensure compliance with the program agreement. When the period for investing expires, the donor may relinquish investment control, and the asset and any proceeds realized by its investment may be transferred to the donee.

U.S. Pat. No. 8,156,000 (Michael P. Thompson), the entire disclosure of which is incorporated herein by reference, relates to facilitating retail transactions between participating enrolled members and participating merchants who fund rebate offers targeted to enrolled members based upon a members past account purchase transaction information, spending habits or member profile information, on qualifying purchases. Account purchase transaction information of merchants funding rebates is monitored by one or more processors at a location(s) other than the participating merchant's location to determine whether a purchase transaction was consummated between an enrolled member and a particular participating merchant, and whether such transaction entitles the member to a merchant funded rebate or reward. The remote monitoring and determining gives the rebate program transparency; no special purpose cards/accounts, or loyalty cards need to be presented by the member and no additional checkout procedures or special equipment are needed by the participating merchants. The rebates or rewards earned can be applied to various accounts, financial instruments or obligations.

U.S. Patent Publication No. 2003/0065572 (Carolyn McNee, et al.), the entire disclosure of which is incorporated herein by reference, relates to a method of donating to charity in which a member shopper recruited by one member merchant, by making a purchase at any member merchant makes a donation to a charity selected by the member shopper. The method comprises receiving a contribution request from the member merchant, the contribution request being responsive to a purchase made by the member shopper at the member merchant and comprising a member shopper identifier, a member merchant identifier, and a purchase amount; associating the member shopper identifier with fields in a database associated with the member shopper, the member shopper's fields including a list of at least one charity previously selected by the member shopper; associating the member merchant identifier with fields in a database associated with the member merchant, the merchant's fields including contribution instructions; storing data relating to the purchase in the member shopper's fields; donating to at least one selected charity, the amount of the donation being based on the purchase amount and the merchant contribution instructions; and, for the member merchant that recruited the member shopper, generating a report that includes information about the purchases made by the member shopper.

U.S. Patent Publication No. 2004/0249735 (Michael Joseph Cassani, et al.), the entire disclosure of which is incorporated herein by reference, discloses an investment fund in which a portion of the assessed investment fund fees and/or investment fund service providers fees are designated for donation to charitable causes as directed by each of the investment fund's shareholders. Shareholders of one or more charitable share classes designate one or more charities to receive the accumulated donation amounts attributable to their individual accounts. Donation amounts are then tracked and paid to charities on a periodic, basis according to the designations on the records of the investment fund.

U.S. Patent Publication No. 2005/0021353 (Karen Aviles, et al.), the entire disclosure of which is incorporated herein by reference, discloses an automatic bill payment enrollment system for recurring donations, which allows donors to automatically charge charitable donations on a recurring basis to a financial account. In one embodiment, the invention uses a donation portal having, various webpages to allow a donor to donate to all U.S. 501(c)(3) organizations. In an alternative embodiment, a donor may donate to any other desired organizations. The system may also incorporate a filter for restricting monies being sent to terrorist organizations. The invention also includes a loyalty point system, wherein loyalty points may be donated to a charity. In another exemplary embodiment, the invention also facilitates employee gift matching.

U.S. Patent Publication No. 2007/0179882 (Richard Intrator), the entire disclosure of which is incorporated herein by reference, discloses a method of increasing cash flow for a not-for-profit entity (201) includes: (a) pledging a donation amount as collateral for a loan amount while the donation amount remains unrealized by the not-for-profit entity; (b) investing the loan amount at an investment rate greater than a lending rate for the loan amount; and (c) pledging the invested loan amount as additional collateral for the loan amount.

U.S. Patent Publication No. 2008/0319898 (Thomas C. Crowl), the entire disclosure of which is incorporated herein by reference, discloses a donation system that would encourage registered individuals to make small contributions to a charity or political campaign (or cause of their choice) as well as facilitate the process of doing so. The system provides a central location for all donation activity and works as a “contribution bundler” to empower those otherwise disempowered in the political marketplace. The system also acts as a “Civic Marketplace” that gives citizens a central location to turn to for civic information. The system provides safety features for registered users.

U.S. Patent Publication No. 2010/0010927 (Garrett D. Melby), the entire disclosure of which is incorporated herein by reference, discloses a method of structuring ownership of an invention including the steps of receiving an investment commitment and a capital contribution from at least one investor, investing the capital contribution in a portfolio company, assigning a set of securities to the at least one investor based upon the capital contribution, the set of securities comprising a plurality of strips, and providing one or more of the plurality of strips to the at least one investor, wherein each of the plurality of strips is defined as a portion of the capital contribution and wherein at least one of the strips is dedicated for donation by the investor to at least one charity.

U.S. Patent Publication No. 2010/0262523 (Daniel Hugh Quigley), the entire disclosure of which is incorporated herein by reference, discloses methods and systems are provided for managing and soliciting; donations made during checkout of a plurality of online purchases at a plurality of online retailers by a plurality of online shoppers. In one embodiment, the method and system include a receiving, over a communications network, data regarding a plurality of amounts for donation and a plurality of selected organizations made during checkout of the plurality of online purchases at the plurality of online retailers by the plurality of online shoppers, and collecting a plurality of payments for the plurality of amounts for donation and distributing the plurality of payments among the plurality of organizations based on the data. The method and system may include the online shoppers being asked at the time of checkout if they would like to round-up their total purchase price to the nearest dollar and select a charity/nonprofit organization to donate the spare change.

U.S. Patent Publication No. 2012/0078762 (David Valin, et al.), the entire disclosure of which is incorporated herein by reference, discloses a method for embedding a socially conscious donation, contribution, payment into a transaction at the point of sale or purchase using any payment platform that accepts, debit, credit, cash, financing, donations, contributions, financial service transactions, etc. and facilitates, separates, and keeps track of the process and the transaction, including the giveback. The system and method also handles contributions to any beneficiary which could be the person making the purchase or sale or barter. The system and method utilizes a human key to make and take requests, record payments, take and certify payments between a user or plurality of users, a merchant/business, and a charity of designated beneficiary. Whereby a set amount by the panics, user, purchaser, seller, and beneficiary can be used for a donation, contribution, or payment to a beneficiary determined at the point of sale, purchase, or barter.

This invention improves on the deficiencies of the prior art and provides an inventive apparatus, system, and method for securing loans for a borrower.

### PURPOSES AND SUMMARY OF THE INVENTION

The invention is a Biniog Sathi apparatus, system, and a method thereof.

Therefore, one purpose of this invention is to find a sustainable solution to the problems of debt default in the financial services industry with the help of Zakat or charity funds.

Another purpose of this invention is to strengthen the existing. Islamic banking model that is being practiced all over the world.

Yet another purpose of this invention is to develop a banking model that will be acceptable to all irrespective of race, color, religion, social class, etc.

Therefore, in one aspect this invention comprises a Biniog Sathi method, comprising the steps of:
(a) providing, at least one means to accept at least one financial deposit from at east one depositor into a financial institution;
(b) providing at least one means to provide at least one financial loan to at least one borrower by said financial institution; and
(c) providing at least one security from at least one charity fund to secure said financial loan from said financial institution for said borrower.

In another aspect this invention comprises a Biniog Sathi apparatus, comprising:
(a) a financial institution having at least one means to electronically accept financial deposits, and at least one means to provide at least one financial loan;
(b) at least one depositor, said depositor providing at least one financial deposit into said financial institution via at least one electronic means;
(c) at least one borrower, said borrower receiving at east one financial loan from said financial institution; and
(d) at least one charity fluid, wherein said charity fund providing at least one security to said financial institution to secure said financial loan for said borrower.

In yet another aspect this invention comprises a program storage device readable by machine, tangibly embodying, a program of instructions executable by the machine to perform method steps for Biniog Sathi method over a network, the method steps comprising:
(a) providing at least one means to accept one financial deposit from at least one depositor into a financial institution;
(b) providing at least one means to provide at least one financial loan to at least one borrower by said financial institution; and
(c) providing at least one security from at least one charity fund to secure said loan from said financial institution for said borrower.

### BRIEF ASCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a typical transaction of an existing, banking or a financial institution.

FIG. 2, illustrates a first embodiment of this invention comprising a transaction utilizing Biniog Sathi.

FIG. 3, illustrates a second embodiment of this invention comprising an inventive transaction between a Zakat or charity fund, and donors and receivers.

FIG. 4, illustrates a third embodiment of this invention comprising an inventive transaction between a Zakat or charity fund, and donors and receivers.

### DETAILED DESCRIPTION

“Biniog Sathi” is a Bangla word from the Bengali language, where “Biniog” means “investment”, and “Sathi” means “friend”. Therefore, “Biniog. Sathi” has been coined to mean “Friend in Investment”. A true friend can never let the life of his/her friend go into ruin or distress if he/she is in financial stress, and goes into default. Biniog Sathi supporters feel that a true financing institution should stand beside it borrowers in both good times and bad times. Thus, this is the essence of Biniog Sathi inventive model or concept.

Under the inventive concept of Biniog Sathi, the concept of Zakat or charity is integrated with the existing Islamic Banking model. In this new model, each participating bank or financial institutions will be renamed as “Biniog Sathi” or “Friend in Investment” or at least provide some indication that it is participating in the Biniog Sathi concept. Like any other bank or financial institution, each Biniog Sathi will collect deposits from the depositors and will channel those funds to the potential borrowers under Sharia compatible or similar financing modes. Depositors will receive their due return from Biniog Sathi, while Biniog Sathi will generate its income through financing the borrowers.

Besides normal lending and deposit operations like any other bank or financial institution, every Biniog Sathi will have relationship with a Zakat or charity fund. One of the objectives of the Zakat fund affiliated with Biniog Sathi will be to provide financial assistance to a debt or if and when he or she fails to make repayments on the loan previously extended by the Biniog Sathi or the Biniog Sathi participating institution.

As one can appreciate that the Biniog Sathi inventive concept is generally related to the financial services industry. It particularly deals with the problem of debt default that persists in the financial services industry all over the world. Any bank or financial institution, no matter whether it is a conventional bank, a credit union. Islamic bank, a Sharia compliant institution, or a micro-finance institution, it is exposed to the possibility of debt default by its borrowers. The Biniog Sathi inventive model offers a solution to the problem of debt default, and helps the existing banks and financial institutions to solve or eliminate this problem of debt default.

According to the Biniog Sathi inventive concept, every participating, bank or financial institution will have a relationship with as Zakat or charity fund. If any borrower defaults or fails to repay the loan of the bank or the financial institution, he/she will be allowed to have access to the Zakat or charity fund, and will be allowed to obtain the required financial assistance from the Zakat or charity fund, which will be equal to the amount due to the bank or the financial institution. Once the appropriate amount has been secured by the borrower, the borrower will then go back to the bank or the financial institution and either repay the due amount or catch-up with the previously established loan repayment schedule.

According to the Islamic Shariah principles, every Muslim citizen is obligated to contribute a certain percentage of his/her wealth for the benefit of certain class of people or for certain noble objectives every year. The classes of people who are eligible to receive Zakat or charity funds or donations or contributions are poor and needy, the Zakat collectors, the new reverts or converts to Islam. Non-Muslims who are sympathetic to Islam, the slaves who need to be freed, people in bondage who need to be freed, any person in debt, any traveler, children on the street, or similar other people. The wealth can also be spent for actions aimed for the cause of God or Allah. This obligatory tax or donation is referred to as Zakat. The literal meaning of the term ‘Zakat’ is to grow in goodness or ‘increase’ or ‘making pure’. So the act of giving Zakat means purifying one's wealth to gain God's blessings to make it grow in goodness. Since Zakat is a form of charity or donation, the words ‘Zakat’, ‘charity’, and “donation” may be used interchangeably.

Under the Biniog Sathi inventive concept the borrower will be able to repay the loan on time and without any escalation of any financial charges, and the bank or the financial institution will be able to obtain the outstanding amount on time, and will have sustainable business without any default of any of its outstanding loans.

According, to Islamic Shariah principles, it is acceptable to use Zakat funds to provide assistance to the loan defaulters. These Zakat funds can also be utilized to provide assistance to the Zakat collectors. These two provisions of the use of Zakat will be used in the Biniog. Sathi inventive model or concept. The Zakat or charity fund will be managed by a team, which will be completely separate from the management of the bank or financial institution under Biniog Sathi concept, and the Zakat collectors will draw their salaries and expenses from the Zakat fund that they will manage. They will periodically collect Zakat or charity from the people, and after meeting the requirements of the loan defaulters, the Zakat balance will be utilized for providing assistance to other groups of people or causes that Islamic Sharia permits.

FIG. 1, illustrates a typical transaction of an existing banking or a financial institution 23. As shown in FIG. 1, a bank or financial institution 10, obtains funds or deposits 12, from depositors 14, and then uses these funds 12, for lending to a borrower 24. The depositors 14, provide the hinds or deposits 12, to the bank or financial institution 10, with an understanding of obtaining a ROI (Return on Investment) 16. The ROI 16, could comprise of a fixed interest rate 16, a variable interest rate 16, a profit sharing scheme 16, or any combination which increases the value of the deposits 12, and which are regularly or periodically provided to the depositors 14, while the funds or deposits 12, are being held by the bank or financial institution 10. Against such lending of the funds or deposits 12, to the borrower 24, the bank or financial institution 10, usually obtains collateral or securities 21, from the borrower 24, such securities 21, might include corporate guarantees 21, personal guarantees 21, pledge/mortgage on certain assets 21, to name a few. The borrower 24, upon receipt of the funds or loan 22, also agrees to not only return the original loan amount 22, but also to provide a mark-up 27. The mark-up 27, could comprise of a fixed interest rate 27, a variable interest rate 27, a profit sharing scheme 27, or any combination which increases the value of the loan amount 22. The mark-up 27, could be provided on a regular or a periodic basis to the financial institution 10. The mark-up 27, could also be a component or a part of a pre-established loan repayment schedule 26, which schedule is established when the borrower 24, obtains the loan 22. From the mark-up 27, the bank or financial institution 10, generates a profit 25, and the ROI 16. If the borrower 24, repays the loan 22, on time, then the bank 10, is able to generate profit 25, and is able to provide return 16, to the depositors 14. However, if and when the borrower 24, defaults or is unable to pay the mark-up 27, along with the loan repayment 26, the bank 10, then exercises its rights on the securities 21, to obtain the mark-up 27, and the balance left on the loan 22. Under such circumstances the borrower 24, could lose everything if he or she suffers a default or is unable to repay the loan 22, and the mark-up 27. Thus, in the existing banking model 23, there is no window for the borrower 24, to receive financial assistance, if they default.

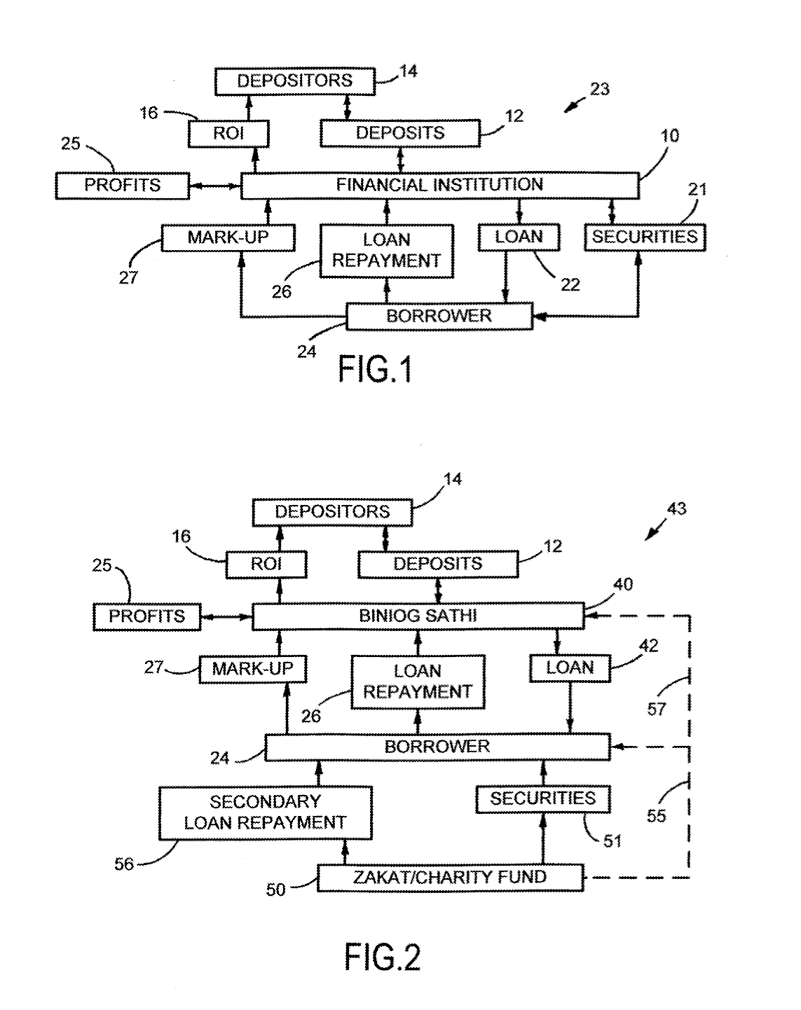

FIG. 2, illustrates a first embodiment of this invention comprising a transaction utilizing Biniog Sathi 43. Under the Biniog Sathi inventive model or concept 43, every bank or financial institution 10, will be renamed as Biniog Sathi 40, or will have some indication that it is a partner of Biniog Sathi 40, and will have a relationship with a Zakat or charity fund 50, which will provide financial assistance to the borrower 24, in case of default. If default occurs, the borrower 24, will have opportunity to have access to the financial assistance from the Zakat fund 50, and use this financial assistance to repay the outstanding loan to the bank 10, 40. The Biniog Sathi inventive model 43, utilizes several features from the existing banking model 23, as illustrated in FIG. 1, however, instead of the borrower 24, providing securities 21, as a collateral 21, the borrower 24, engages the Zakat or charity fund 50, which in one sense provides a collateral or securities 51, to the institution participating as Biniog Sathi 40, while obtaining the loan 42. During the origination of the loan 42, Biniog Sathi participating institution 40, the borrower 24, and the Zakat or charity fund 50, have an agreement via process 55, 57, as to the rights and obligations of each of the participating, party 40, 24, 50. For some transactions the Biniog Sathi inventive model 43, could include a secondary loan repayment concept 56, which would allow the borrower 24, to partially or fully access the secondary loan repayment schedule 56, to partially or fully repay the loan 42, using, the secondary loan repayment schedule 56. The criteria for establishing access to the secondary loan repayment schedule 56, could be universal or could be customized for each borrower 24, or could be based on any criteria, such as, need, change in circumstances, business or personal reasons, to name a few.

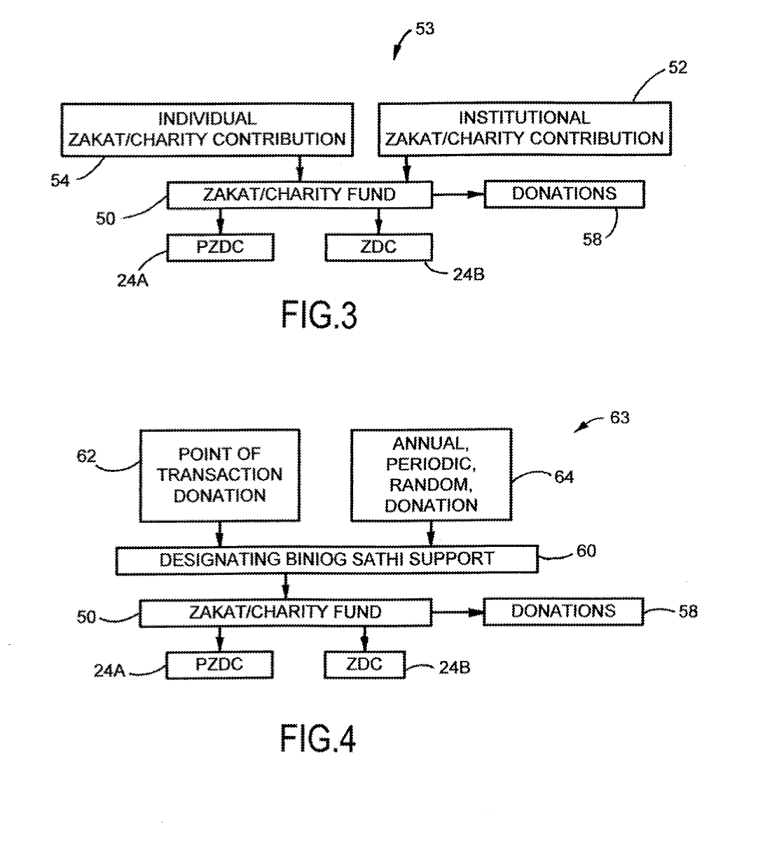

FIG. 3, illustrates a second embodiment of this invention 53 comprising an inventive transaction 53, between a Zakat or charity fund 50, and donors 52, 54, and receivers 24A, 24B. Using the Biniog Sathi inventive model 43, in order to provide the Zakat or Charity fund 50, with sufficient funds, it is contemplated that individual contributors 54, and institutional contributors 52, would make their regular or periodic donations or contributions to the Zakat or charity fund 50. The Zakat or charity fund 50, in turn would help borrowers 24, at their time of need, as already discussed with reference to FIG. 2, and any surplus within the Zakat or charity fund 50, would be donated via donations 58, according to either established Sharia Islamic law, or on a criteria according to the charter of the Zakat or charity fund 50. It should be appreciated that the borrowers 24, could comprise of at least two different group of borrowers 24. The first group of borrowers 24, could be termed the Partially Zakat Dependent Client (PZDC) 24A, and the second group of borrowers could be classified as Zakat Dependent Client (ZDC) 24B. One could also establish other criteria to classify the borrowers 24, such as, on the basis of the assistance received from the Zakat fund 50, to classify the at least two groups, namely, the Partially Zakat Dependent Client (PZDC) 24A, and the Zakat Dependent Client (ZDC) 24B. This information could also be used fur the amount, and/or terms and conditions for the future financing to these two groups of borrowers 24A, 24B, and it could also vary on the basis of their previous dependency on the Zakat or charity funds 50. For example, the less a borrower 24, 24A, 24B, is dependent upon the Zakat or charity fund 50, the more rewarding the future financing or security 51, or secondary loan repayment 56, could be.

FIG. 4, illustrates a third embodiment of this invention 63, comprising an inventive transaction 63, between a Zakat or charity fund 50, and donors 62, 64, and receivers 24A, 24B. Using the Biniog Sathi inventive model 43, in order to provide the Zakat or charity fund 50, with sufficient funds, it is contemplated that the Zakat or charity fund 50, would accept point of transaction donations 62, and/or annual, periodic, random, donations 64, where the donor 62, 64, would designate Biniog Sathi institution 60, as either the recipient 60, or one of the recipient 60, of the donation by the donor 62, 64 to the Zakat or charity fund 50. As stated earlier that the Zakat or charity fund 50, would in turn help borrowers 24, 24A, 24B, at their time of need, as already discussed with reference to FIGS. 2, and 3, and an surplus within the Zakat or charity fund 50, would be donated via donations 58, according to either established Sharia Islamic law, or on a criteria according to the charter of the Zakat or charity fund 50.

As one can appreciate that the Biniog Sathi inventive model 43, provides an alternative banking model 43, that solves the problem of debt default, and offers a simple and practical solution to the problem of debt default within the existing banking systems or institutions.

It is preferred that the Zakat or charity fund 50, be a separate entity 50, and be completely independent of the management of Biniog Sathi 40. The Zakat or charity fund 50, will have its own employees to collect Zakat or charity from the people or donors 54, 62, 64, or institutions 52, and they will draw their salaries or wages from the Zakat or charity fund 50, and since it is permissible in the Islamic Sharia law for the Zakat collectors to accept payment or compensation from the Zakat collected. Therefore, the source of the capital of Biniog Sathi 40, and the Zakat fund 50, will be completely different from each other.

The Biniog Sathi inventive model 43, is more economically competitive compared to conventional, Islamic or microfinance banking models due to numerous factors, such as, for example, the Biniog Sathi inventive model 43, complies with all Sharia Islamic principles, and at the same time, resolves the problem of debt default. Thus, it strengthens the existing Islamic banking model by incorporating the concept of Zakat or charity fluid 50. The borrower 24, under the Biniog Sathi inventive model 43, does not have to worry about being ruined by losing everything if he or she goes into default and at the same time the bank or financial institution 30, does not need to force the borrower 24, to pay of the loan which is a usual case for a contemporary financial institutions 10, under similar circumstances.

Biniog Sathi inventive model strengthens the present Islamic banking model because the model complies with the verse 280 of Sura Baqara of the Holy Quran. The verse says, “If the debtor is in a hard time, then grant him time till it is easy for him to repay, but if you remit it by way of charity, that is better for you if you did but know”. Since there is a restriction in sharia or Islamic law to force borrowers in case of a delayed payment, present Islamic banks charge a penalty to the borrower in case the loan payment is delayed and donate this sum or amount to a charity. This is done due to the problems of moral hazard. If such penalty is not enforced, the borrowers will have incentives to delay the payments of loans for Islamic banks. Biniog Sathi inventive model resolves this problem by incorporating the Zakat Fund, and therefore, strengthens the Islamic banking model by fully complying with the sharia rules.

The borrower 24, does not have to offer any real asset(s) as collateral 21, against the financing 22. It is because as long as the Biniog Sathi 40, has the support from the Zakat or charity fund 50, and it has the sufficient balance, the Biniog Sathi 40, will not run any risk of bad debts.

Within the financial institution 10, 40, the definition of credit risk will change due to the support from the Zakat or charity fund 50, and the Biniog Sathi 40, will be able to offer loans 42, to the borrower 24, at a more competitive rate than the market.

In the conventional banking system 23, the government might have to intervene into the banking, system 23, in case of mass default of the borrowers 24. However, under the Biniog Sathi banking system 43, such intervention is unlikely to happen due to the absence of default by the borrowers 24.

This is the first time the concept of Zakat or charity fund 50, is being incorporated in the banking system 10, 40, that will provide financial assistance to the borrowers 24, if they default.

The incorporation of the Zakat or charity fund 50, with the existing banking system 23, strengthens the existing Islamic banking model by resolving the problems of debt default.

The classification of the borrowers 24, in terms of their dependence on the Zakat fund 50, is a new concept. As stated earlier under the Biniog Sathi inventive model 43, the borrower 24, can be classified as partially Zakat dependent client (PZDC) 24A, and the Zakat dependent client (ZDC) 24B, in terms of their dependency on the Zakat fund 50, in case of default.

At the end of the calendar year, or fiscal year, or a pre-established point of time the Zakat or charity fund 50, after meeting all the Zakat or financial requirements of the borrowers 24, 24A, 24B who faced full or partial default of loans 42, the remaining balance of the Zakat or charity fund 50, would be spent on other charitable areas or donations 58, which are permitted under the Sharia Islamic principles, or on a criteria according to the charter of the Zakat or charity fund 50.

Under the Biniog Sathi inventive concept 43, there is less likelihood that Government would need to intervene in the banking system 10, 40, in case of mass default of the borrowers 24. It is due to the available support of the Zakat or charity fund 50. This is a new concept in the existing banking system 23. Therefore, if all the existing banks/financial institutions 23, adopt Biniog Sathi inventive concept 43, the resultant financial system would be more stable.

Biniog Sathi Model 43, incorporates the concept of Zakat or charity fund 50, with the existing banking system 23, under which a borrower 24, will have access to financial assistance in case he or she defaults on bank loans 42. If the borrower 24, defaults on a loan 42, extended by a bank 40, then he or she will obtain financial assistance from the Zakat or charity fund 50, and will partially or fully pay-off the loan 42. The amount of Zakat assistance will be equal to the amount due to the bank 40, or amount needed by the borrower 24. Therefore, the bank 40, be able to obtain its unpaid amount, and the borrower 24, will be able to be free from any debt obligations 42. This will help banks 40, to reduce their credit risks, and as a result, banks 40, will tend to extend loans 42, without any security 21, as long as there is sufficient balance in the Zakat or charity fund 50. This will eventually help to eliminate the problem of debt default from the existing banking system 23.

As discussed earlier, if and when, the borrower 24, faces problem in repaying the loan amount 42, he/she might opt for receiving financial assistance front the Zakat window 50, of Biniog Sathi 40. The assistance might be equal to the missed installment or less depending on the financial capacity of the borrower 24. After obtaining the financial assistance from the Zakat or charity fund 50, the borrower 24, will repay the outstanding amount of the loan 42, to Biniog Sathi 40, and thus will be free from any debt obligations. Biniog Sathi 40, will also be benefited from getting the loan 42, repaid from the borrower 24, without any additional expenses, such as, for example, using a debt collector, or a court proceeding, or writing-off the debt 42, to name a few.

The Biniog Sathi inventive model or concept 43, has been presented using Islamic principles, however, it should be understood that the Biniog Sathi inventive model or concept 43, can be used by any organization or institution as long as the essential features of the Biniog Sathi inventive model or concept 43, are present, such as, a depositor 14, a borrower 24, a Biniog Sathi supportive institution or organization 40, and a charitable organization 50, that is willing or has the capacity to provide security 51, to the lending institution 40, and then be able to assist both the borrower 24, and the financial institution 40, in a debt delimit situation.

The Biniog Sathi inventive model or concept 43, can be replicated by any financial institution, however, it should be understood that for replication, the financing modes and the activities of the replicating institution have to comply with the sharia principles. Since the invention of the Biniog Sathi inventive model or concept 43, is religion neutral, complying with such requirements will allow religious Muslims to have access to financing from a replicating financing institution no matter whether it is operated by Christians, Jews, Hindus, or any other religious or non-religious group or institution.

It is also contemplated that individuals or institutions or organizations managing the Zakat or charity fund 50, could designate that a portion or a certain amount of the Zakat or charity fund 50, collected be designated towards the support of the Biniog Sathi inventive model or concept 43. The amount designated in support of the Biniog Sathi inventive model or concept 43, could vary from about zero percent to about 100 percent or any amount or percentage in-between.

It should be appreciated that there are banks or financial institutions that do not collect deposits from depositors, for example, International Development Bank, World Bank, Non-Bank Financial Institutions, to name a few. These banks or financial institutions do not collect deposits, but rather uses their capital for lending operations. These banks and financial institutions can also benefit from Biniog Sathi model.

It should be understood that various electronic components associated with the Biniog Sathi inventive model or concept 43, have not been shown with reference to FIGS. 1-4, however, those electronic components are well known in the art, such as, a computer, an electronic tablet, a smart phone, a personal digital assistant (PDA), a wireless network, a wired network, the Internet, to name a few.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A Biniog Sathi method, comprising the steps of:
(a) providing at least one means to accept at least one financial deposit from at least one depositor into a financial institution, and entering said at least one financial deposit into at least one computer at said financial institution;
(b) setting-up at least one independent charity fund, and forming a relationship between said at least one independent charity fund and said financial institution;
(c) providing at least one means to provide at least one financial loan to at least one borrower by said financial institution from said at least one financial deposit: and
(d) providing at least one means for said borrower to use funds from said at least one independent charity fund as security to secure said financial loan from said financial institution.

2. The Biniog Sathi method of claim 1, wherein said financial institution provides a return on investment to said depositor against said at least one financial deposit.

3. The Biniog Sathi method of claim 1, wherein said financial institution provides a return on investment to said depositor against said at least one financial deposit, and wherein said return on investment is selected from a group consisting of a fixed interest rate, a variable interest rate, a profit sharing scheme, and any combination thereof.

4. The Biniog Sathi method of claim 1, wherein said financial institution charges a markup for said financial loan by said at least one borrower.

5. The Biniog Sathi method of claim 1, wherein said at least one security from said at least one independent charity fund comprises of at least one charitable asset of said at least one independent charity fund.

6. The Biniog Sathi method of claim 1, wherein at least one entity provides at least one charitable contribution to said at least one independent charity fund.

7. The Biniog Sathi method of claim 1, wherein at least one entity provides at least one charitable contribution to said at least one independent charity fund, and wherein said entity designates a percentage of said at least one charitable contribution towards Biniog Sathi.

8. The Biniog Sathi method of claim 1, wherein at least one entity provides at least one charitable contribution to said at least one independent charity fund, and wherein said entity designates a percentage of said at least one charitable contribution towards Biniog Sathi, and wherein said percentage is between zero percent and one hundred percent of said at least one charitable contribution.

9. The Biniog Sathi method of claim 1, wherein at least one entity provides at least one charitable contribution to said at least one independent charity fund, and wherein said charitable contribution is made at a point selected from a group consisting of point of transaction donation, an annual donation, a periodic donation, a random donation, any combination thereof.

10. The Biniog Sathi method of claim 1, wherein at least one entity provides at least one charitable contribution to said at least one independent charity fund, and wherein said entity is selected from a group consisting of an individual donor, and an institutional donor.

11. The Biniog Sathi method of claim 1, wherein upon default by said borrower of said financial loan said at least one independent charity fund provides a loan repayment against the balance of any amount due on said financial loan.

12. The Biniog Sathi method of claim 1, wherein upon default by said borrower of said financial loan said at least one independent charity fund provides a loan repayment against the balance of any amount due on said financial loan, and wherein said borrower is then classified from a group selected from a partially Zakat dependent client (PZDC), and a Zakat dependent client (ZDC).

13. The Biniog Sathi method of claim 1, wherein said financial institution has at least one department to process Biniog Sathi applications.

14. The Biniog Sathi method of claim 1, wherein said financial institution generates financial profits from said borrower of said financial loan.

15. The Biniog Sathi method of claim 1, wherein said financial institution generates financial profits from said borrower of said financial loan, and wherein a portion of said financial profit is provided to said depositor as a return on investment.

16. The Biniog Sathi method of claim 1, wherein said financial institution is selected from a group consisting of a conventional bank, a credit union, an Islamic bank, a Sharia compliant institution, and a micro-finance institution.

17. A Biniog Sathi system, comprising:
(a) a financial institution having at least one means to electronically accept and record financial deposits on a computer, and at least one means to provide at least one financial loan;
(b) at least one depositor, said at least one depositor providing at least one financial deposit into said financial institution via at least one electronic means;
(c) at least one borrower, said borrower receiving at least one financial loan from said at least one financial deposit from said financial institution; and
(d) at least one independent charity fund, wherein said at least one independent charity fund is associated with said financial institution, and wherein said borrower uses said at least one independent charity fund to provide at least one security to said financial institution to secure said financial loan for said borrower.

18. (canceled)

19. A non-transitory computer-readable storage medium with an executable pro ram application stored thereon, the program application configured for coordinating to perform transactions associated with a financial institution, the program application configured to be accessible over a communications network, wherein the program application instructs a computer processor to perform the following steps of:
(a) receiving instructions to accept at least one financial deposit from at least one depositor into said financial institution, and entering said instructions for said at least one financial deposit into at least one computer at said financial institution;
(b) receiving a set of instructions from at least one independent charity fund;
(c) verifying that a relationship exists between said at least one independent charity fund and said financial institution;
(d) processing at least one financial loan for at least one borrower upon instructions from said financial institution from said at least one financial deposit; and
(e) confirming that said at least one independent charity fund has sufficient security funds to secure said financial loan from said financial institution for said borrower.

20. The non-transitory computer-readable storage medium of claim 19, wherein funds into said at least one independent charity fund are electronically deposited via charitable contribution into said at least one independent charity fund, and wherein said charitable contribution is made at a point selected from a group consisting of point of transaction donation, an annual donation, a periodic donation, a random donation, and any combination thereof.

21. The non-transitory computer-readable storage medium of claim 9, wherein said financial institution is selected from a group consisting of a conventional bank, a credit union, an Islamic bank, a Sharia compliant institution, and a micro-finance institution.
